(19) United States
(12) Patent Application Publication
(10) Pub. No.: US 2024/0292325 A1
(43) Pub. Date: Aug. 29, 2024

(54) SYSTEMS AND METHOD FOR EXTENDING TARGET WAKE TIME SERVICE PERIOD

(71) Applicant: Meta Platforms Technologies, LLC, Menlo Park, CA (US)

(72) Inventors: Muhammad Kumail Haider, Sunnyvale, CA (US); Binita Gupta, San Diego, CA (US); Chunyu Hu, Saratoga, CA (US)

(73) Assignee: Meta Platforms Technologies, LLC, Menlo Park, CA (US)

(21) Appl. No.: 18/426,685

(22) Filed: Jan. 30, 2024

Related U.S. Application Data
(60) Provisional application No. 63/448,798, filed on Feb. 28, 2023.

(51) Int. Cl. H04W 52/02; H04W 84/12

(52) U.S. Cl. CPC H04W 52/0216; H04W 84/12

(57) ABSTRACT

A first device may include one or more processors. The one or more processors may be configured to generate, during a service period of a target wake time (TWT) schedule, a first frame requesting a second device in a wireless local area network (WLAN) to extend the service period, and wirelessly transmit, via a transceiver, the generated first frame to the second device. One of the first device or the second device is an access point.

### CROSS-REFERENCE TO RELATED APPLICATION

This application claims priority to U.S. Provisional Patent Application No. 63/448,798 filed on Feb. 28, 2023, which is incorporated by reference herein in its entirety for all purposes.

### FIELD OF DISCLOSURE

The present disclosure is generally related to communications, including but not limited systems and methods of extending a service period (SP) of a target wake time (TWT) schedule for wireless communication.

### BACKGROUND

Artificial reality, such as a virtual reality (VR), an augmented reality (AR), or a mixed reality (MR), provides immersive experience to a user. In one example, a user wearing a head wearable display (HWD) can turn the user's head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device may have access to a network.

### SUMMARY

Various embodiments disclosed herein are related to a first device including one or more processors. The one or more processors may be configured to generate, during a service period of a target wake time (TWT) schedule, a first frame requesting a second device in a wireless local area network (WLAN) to extend the service period, and wirelessly transmit, via a transceiver, the generated first frame to the second device. One of the first device or the second device is an access point.

In some embodiments, the one or more processors may be configured to set a first subfield of the first frame to a traffic identifier (TID) and a second subfield of the first frame to a specific serial number or sequence number, to request the second device to extend the service period until the second device receives all frames having serial numbers or sequence numbers that are less than or equal to the specific serial number or sequence number for a traffic stream with the TID.

In some embodiments, the one or more processors may be configured to set a subfield of the first frame to a minimum wake duration to request the second device to extend the service period for the minimum wake duration beyond an end time of the service period.

In some embodiments, the first frame may include a subfield indicating a buffer size of traffic corresponding to one or more traffic identifiers (TIDs) or one or more access categories (ACs) associated with the service period, and the one or more processors may be configured to set the subfield to a non-zero value to request the second device to extend the service period.

In some embodiments, the first frame may include a subfield indicating power management of the first device, and the one or more processors may be configured to set the subfield to indicate that the first device is in (or switches to) an active mode, to request the second device to extend the service period.

In some embodiments, the one or more processors may be configured to receive, via the transceiver from the second device, a second frame indicating that the service period has been extended, responsive to receiving the second frame, wirelessly transmit, via the transceiver to the second device, a data frame after an end time of the service period, and receive, via the transceiver from the second device, a third frame indicating that the service period has been terminated.

In some embodiments, the one or more processors may be configured to responsive to receiving the second frame, switch the first device to an active mode, and responsive to receiving the third frame, switch the first device from the active mode to a power save mode.

In some embodiments, the second frame may include a subfield of the first frame set to a value indicating that the service period has been extended, and the subfield may include one of (1) a subfield indicating whether there is a subsequent trigger frame, (2) a subfield indicating whether the service period has ended, or (3) a subfield indicating whether the first device has more data to send to the second device.

In some embodiments, the second frame may include a quality of service (QOS) control field that includes a subfield set to a value indicating that the service period has been extended.

In some embodiments, the third frame may include a subfield of the first frame set to a value indicating that the service period has been terminated, and the subfield may include one of (1) a subfield indicating whether there is a subsequent trigger frame, (2) a subfield indicating whether the service period has ended, or (3) a subfield indicating whether the first device has more data to send to the second device.

Various embodiments disclosed herein are related to a method. The method includes generating, by a first device during a service period of a target wake time (TWT) schedule, a first frame requesting a second device in a wireless local area network (WLAN) to extend the service period, and wirelessly transmitting, by the first device via a transceiver, the generated first frame to the second device. One of the first device or the second device is an access point.

In some embodiments, the method may include setting a first subfield of the first frame to a traffic identifier (TID) and a second subfield of the first frame to a specific serial number or sequence number, to request the second device to extend the service period until the second device receives all frames having serial numbers or sequence numbers that are less than or equal to the specific serial number or sequence number for a traffic stream with the TID.

In some embodiments, the method may include setting a subfield of the first frame to a minimum wake duration to request the second device to extend the service period for the minimum wake duration beyond an end time of the service period.

In some embodiments, the first frame may include a subfield indicating a buffer size of traffic corresponding to one or more traffic identifiers (TIDs) or one or more access categories (ACs) associated with the service period, and the method may include setting the subfield to a non-zero value to request the second device to extend the service period.

In some embodiments, the first frame may include a subfield indicating power management of the first device, and the method may include setting the subfield to indicate that the first device is in (or switches to) an active mode, to request the second device to extend the service period.

In some embodiments, the method may include receiving, via the transceiver from the second device, a second frame indicating that the service period has been extended, responsive to receiving the second frame, wirelessly transmitting, via the transceiver to the second device, a data frame after an end time of the service period, and receiving, via the transceiver from the second device, a third frame indicating that the service period has been terminated.

In some embodiments, the method may include responsive to receiving the second frame, switching the first device to an active mode, and responsive to receiving the third frame, switching the first device from the active mode to a power save mode.

In some embodiments, the second frame may include a subfield of the first frame set to a value indicating that the service period has been extended, and the subfield may include one of (1) a subfield indicating whether there is a subsequent trigger frame, (2) a subfield indicating whether the service period has ended, or (3) a subfield indicating whether the first device has more data to send to the second device.

In some embodiments, the second frame may include a quality of service (QOS) control field that includes a subfield set to a value indicating that the service period has been extended.

In some embodiments, the third frame may include a subfield of the first frame set to a value indicating that the service period has been terminated, and the subfield may include one of (1) a subfield indicating whether there is a subsequent trigger frame, (2) a subfield indicating whether the service period has ended, or (3) a subfield indicating whether the first device has more data to send to the second device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is an example format of an aggregate control (A-control) subfield of a control field for indicating a request for an extension of a TWT service period (SP), according to an example implementation of the present disclosure.

FIG. 6 is a table of example values and description for the A-control field, according to an example implementation of the present disclosure.

FIG. 7 is a schematic view of an example extension of a TWT SP using the A-control field, according to an example implementation of the present disclosure.

FIG. 8 is an example format of an A-control subfield of a control field for indicating a request for an extension of a TWT SP, according to an example implementation of the present disclosure.

FIG. 9 is a flowchart showing a method of performing an extension of a TWT SP, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

TWT can be a time agreed/negotiated upon by devices (e.g., access points (APs) and/or stations (STAs)), or specified/configured by one device (e.g., an AP). During the wake time, a first device (e.g., a STA) may be in an awake state (e.g., its wireless communication module/interface is in a fully powered-up ready, or wake state) and is able to transmit and/or receive. When the first device is not awake (e.g., its wireless communication module/interface is in a powered-down, low power, or sleep state), the first device may enter a low power mode or other sleep mode. The first device may exist in the sleep state until a time instance/window as specified by the TWT.

TWT is a mechanism where a set of service periods (SPs) are defined and shared between devices to reduce medium contention and improve the power efficiency of the devices. For example, the first device can wake up periodically (e.g., at a fixed, configured time interval/period/cycle) based on the TWT. The TWT reduces energy consumption of the devices by limiting the awake time and associated power consumption of the devices.

An AP (e.g., AP and/or other device operating as a soft AP/hotspot) may enhance medium access protection and resource reservation by supporting restricted TWT (rTWT). The rTWT SPs may be used to deliver latency sensitive traffic and/or any additional frame that supports latency sensitive traffic.

Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user's view of the space of the artificial reality according to the sensor measurements, and generate an image of the space of the artificial reality corresponding to the user's view. The console device can transmit the generated image to the HWD, by which the image of the space of the artificial reality corresponding to the user's view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

Disclosed herein includes systems, devices and methods for STAs and/or APs to negotiate extension of a TWT SP using a new/specific signaling (e.g., frame formats and/or sequences for SP extension negotiation). A new/specific signaling for STAs to request and grant SP extension, including frame exchanges for request/grant, may be defined. A STA may request an extension of an SP, and an AP may accept/reject the request. In some embodiments, an AP may request an extension of an SP, and a STA may accept/reject the request.

In one aspect, a new signaling for SP extension may be defined using a new aggregate control field (e.g., high efficiency (HE) A-control field in a MAC header). In one aspect, a new signaling for SP extension may use Buffer Status Report (BSR) mechanism (e.g., by delivery of a non-zero buffer). In one aspect, a STA (or AP) may switch power state of the STA as a signaling for SP extension. In one aspect, a new/specific signaling for SP extension may define frame sequences that support/enable or lead to termination of such extended SPs.

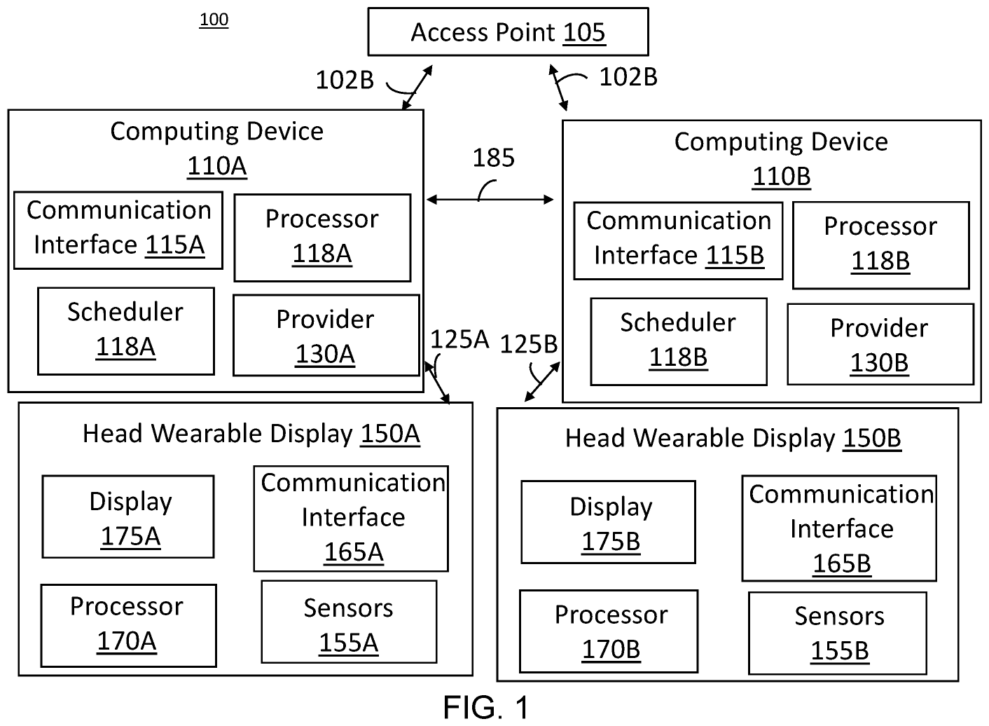

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is-10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request a rTWT schedule/configuration to transmit latency sensitive traffic using P2P communication. The AP 105 and scheduler 118 of the computing devices 110 may negotiate (e.g., perform a handshake process) and may establish a membership of/to a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

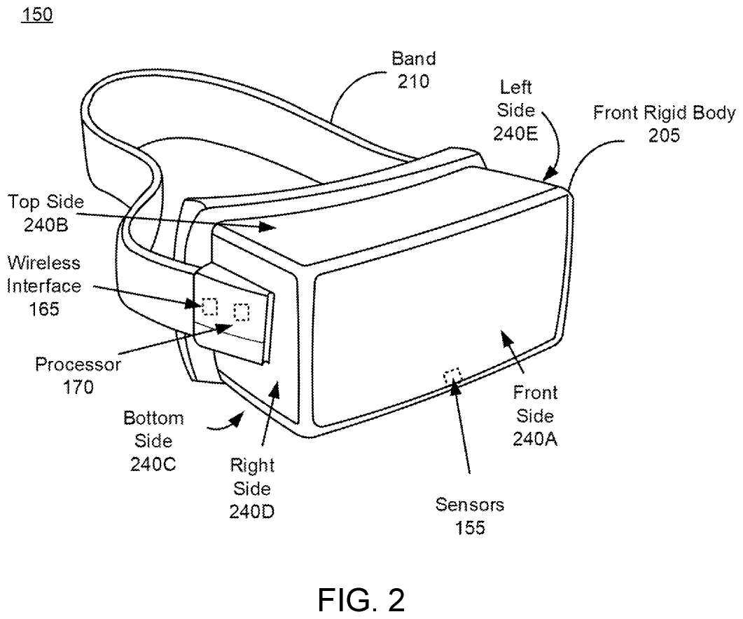

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

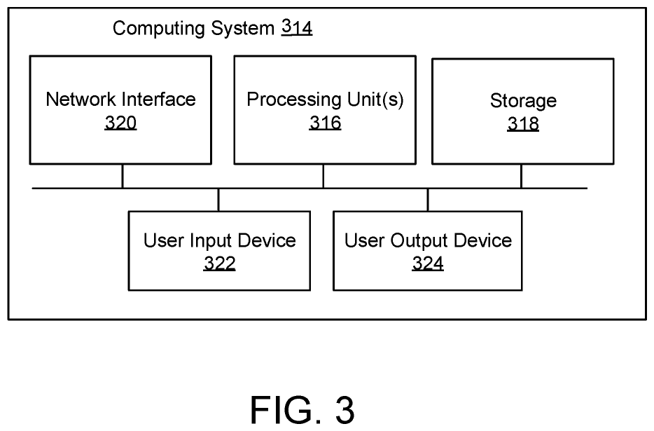

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

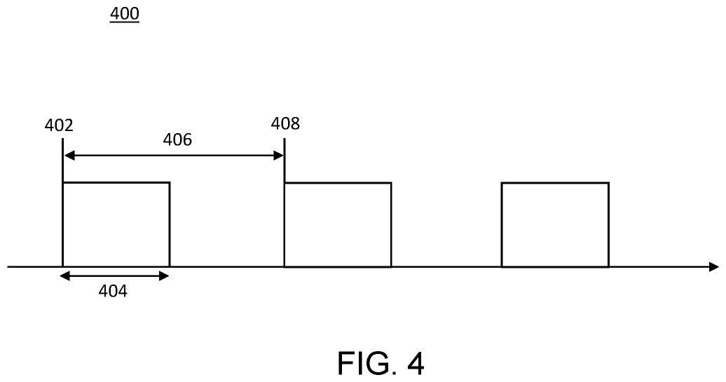

FIGS. 1-2 illustrate devices that communicate traffic streams some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406.

A TWT schedule may be communicated and/or negotiated using broadcast TWT (bTWT) and/or individual TWT (iTWT) signaling. In some embodiments, to signal iTWT, TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or rTWT) in P2P communication. Accordingly, a P2P model where a P2P STA (e.g., a HWD 150) is not associated with an infra-basic service set (BSS) AP, may improve P2P communication. Without AP's assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Stations (STAs) can setup service periods (SPs) to exchange traffic with an access point (AP). An STA may be awake at the beginning of an SP and switch to a “sleep” state outside the SP to save the power. However, at the end of the SP, the traffic scheduled for delivery during a target wake time (TWT) SP may not be completely delivered due to various reasons (e.g., a traffic size, a channel condition, an Overlapping Basic Service Set (OBSS), an interference, a late start of the SP, etc.). For example, an OBSS can cause interference/congestion, which could affect the timely delivery of traffic. In addition, such reasons could cause a delay in delivering the data exceeding an acceptable bound or threshold, leading to potential loss of data integrity and poor user experience. Thus, it would be beneficial to ensure timely delivery of traffic to facilitate STAs' power saving.

To address this problem, systems and/or methods for extending a TWT SP can be provided/defined. STAs and/or APs can negotiate extension of a TWT SP using a newly-defined signal (e.g., frame sequences for the negotiation) or a modified signal. For example, a STA can request an extension of an SP, and an AP can accept/reject the request, according (or in response) to the newly-defined signal or the modified signal. For example, an AP can request an extension of an SP, and a STA can accept/reject the request, according to the newly-defined signal or the modified signal. In some embodiments, a signal, including frame exchanges for an STA to request and/or grant an SP extension, can be defined. In some embodiments, a signal, including a modified value on a subfield for an STA to request and/or grant an SP extension, can be defined. In some embodiments, a signal, including frame sequences indicating a termination of such an extension, can be defined.

In one aspect, during a SP of a TWT schedule, a first device (e.g., a non-AP STA, an AP, etc.) can generate a first frame requesting a second device in a wireless local area network (WLAN) to extend the SP, and can wirelessly transmit, via a transceiver, the generated first frame to the second device. In some embodiments, one of the first device or the second device may be an AP. In some embodiments, the first device can generate (or configure, reconfigure, etc.) the first frame in various manners to request the second device to extend/prolong the SP, as discussed in greater detail below. By transmitting the generated first frame, including the request, to the second device, the first device can request the SP extension. In some embodiments, the first frame may be or include an SP extension frame for the first device to request an SP extension. The first frame may include a new aggregate control field (A-control field).

In some embodiments, the A-control field may be a High Efficiency (HE) variant control field in a medium access control (MAC) header. In some embodiments, the A-control field can be used for an SP extension or any other SP management (e.g., TWT SP management). In some embodiments, the A-control field can include various elements for the SP management (e.g., SP extension). In some embodiments, the A-control field may include a Control ID field and/or a Control Information field, and each field can include one or more subfields.

In some embodiments, the Control ID field can include a subfield for identifying the SP management (e.g., SP extension). In some embodiments, a size of the Control ID field may be 4 bits. In some embodiments, the Control Information field can include a Command subfield to specify a request for an SP extension or a response to an SP extension. By specifying the Command subfield, one or more of the plurality of subfields within the Control Information field can be set and/or defined to define the A-control field. In some embodiments, the Control Information field can include a reserved (Rsvd) subfield that can be further specified (e.g., in the future). In some embodiments, the Control ID field can include a reserved (Rsvd) subfield that can be further specified (e.g., in the future). In a non-limiting example, the Control ID field may be 4 bits, the Command subfield may be 3 bits, and the Rsvd subfield may be 1 bit.

In some embodiments, the Control Information field can include a plurality of subfields for the SP management (e.g., SP extension). In some embodiments, the Control Information field can include a traffic identifier (TID) subfield to indicate an identification of the traffic. In some embodiments, the Control Information field can include a serial number (SN) subfield to indicate a serial number and/or a sequence number of the frame. In some embodiments, the Control Information field can include a Last SN subfield to indicate the last sequence number for the SP. In some embodiments, the Control Information field can include a subfield to indicate an Additional Minimum Wake Duration. This subfield can define and/or specify an additional duration of an SP to be requested. Discussed herein are non-limiting examples of the subfields, and various subfields can be set and defined to define the A-control field to request the SP extension in various manners.

In some embodiments, the Control Information field can be configured to define a request for an SP extension such that the second device can extend the SP until the SP is explicitly terminated or no buffer is available (e.g., when the second device runs out of the buffer for the first device or the STA transmitting the traffic). In some embodiments, the subfields (e.g., the TID subfield, the Last SN subfield, the subfield (for Additional Min Wake Duration), etc.) can be set to “Reserved” to be further specified. In some embodiments, the Command subfield can be specified as “0.”

In some embodiments, the Control Information field can be configured to define a request for an SP extension such that the second device can extend the SP until the second device receives all frames having SNs that are less than or equal to a specific SN for a traffic stream with the TID. For example, the second device can extend the SP until the second device receives all frames having SNs that are less than or equal to the SN of the last frame (e.g., an SN specified in the Last SN subfield) for the specified TID. For example, the second device can extend the SP until the second device receives all bufferable units (BUs) for all SNs that are less than or equal to the SN of the last frame (e.g., an SN specified in the Last SN subfield) for the specified TID. In some embodiments, a first subfield of the first frame (e.g., TID subfield) can be set to a TID, and a second subfield of the first frame (e.g., Last SN subfield) can be set to a specific SN, in order to define the request, while the other subfields (e.g., Min Wake Duration, etc.) can be set to “Reserved” to be further specified for various purposes. In some embodiments, the Command subfield can be specified as “1.”

In some embodiments, the Control Information field can be configured to define a request for an SP extension such that the second device can extend the SP for a minimum wake duration beyond an end time (e.g., a configured end time) of the SP. For example, the second device can extend the SP for a duration (e.g., specified in the subfield of Additional Min Wake Duration (e.g., in time unit (TU)) beyond the current end time of the on-going SP). In some embodiments, a subfield of the first frame can be set to specify an Additional Min Wake Duration, in order to define the request, while the other subfields (e.g., TID, Last SN, etc.) can be set to “Reserved” to be further specified for various purposes. In some embodiments, the Command subfield can be specified as “2.”

In some embodiments, the Control Information field can be configured to define a response to an SP extension request such that the first device can notify the second device that the SP has been extended. In some embodiments, the first device can notify the second device that the SP has been extended in a manner specified in the SP extension request (e.g., in a manner discussed above). In some embodiments, the first device can notify the second device that the SP has been extended, for example, until the specified Additional Min Wake Duration (e.g., if the subfield therefor has a non-zero value), or until explicitly terminated. In some embodiments, at least one subfield of the first frame can be set to Additional Min Wake Duration, TID, or Last SN, in order to define the response to the SP extension request, while the other subfields can be set to “Reserved” to be further specified for various purposes. For example, a subfield of the first frame can be set to Additional Min Wake Duration, while the subfields of TID and Last SN can be set to “Reserved” to be further specified for various purposes. In some embodiments, the Command subfield can be specified as “3.” In some embodiments, the Command subfield can include one or more bits that can be further specified (e.g., “Reserved”) for various purposes. For example, the Command subfield can be 8 bits, and the fifth to eighth bit can be further specified (e.g., “Reserved”) for various purposes.

In some embodiments, an STA (or an AP) can request an extension and an AP (or an STA) can respond to the extension request according to the A-control field discussed above and configuration thereof. When a TWT SP with an original period of T1 begins at T=0, an STA and an AP can communicate data within the TWT SP. For example, the AP can send data, and the STA can acknowledge as a block (e.g., send a Block ACK frame) to confirm receipt of the data. For example, the STA can send data, and the AP can send a Block ACK frame to confirm receipt of the data. In some embodiments, the STA can send the data along with a frame including the A-control field to request an SP extension, which can vary according to how the extension is defined in the A-control field. For example, the STA can include, within or along with the data, a frame including a TWT SP Management field with the Command subfield of “2” (e.g., with specified Additional Min Wake Duration, T2). In response to receipt of the request (e.g., within the data from the STA), the AP can acknowledge as a block to confirm receipt of the data and the extension request. In some embodiments, in order to respond to the request, the AP can accept the request and notify the STA with the Command subfield of “3.” In some embodiments, the AP can acknowledge as a block to confirm receipt of the data from the STA while sending a frame including a TWT SP Management field with the Command subfield of “3” to convey an acceptance of the request. In some embodiments, the AP can reject the request. In some embodiments, the AP can send a frame including Quality of Service (QOS) related information (e.g., QOS NULL) along with an acceptance of the request. The AP can thereby accept and extend the SP from the original period T1 to an extended SP duration of T1+T2 (e.g., if an additional period of T2 is requested) or extend until explicitly terminated. In response to the extension of the SP, the STA can further send data to the AP, and the AP can confirm receipt of the data by sending a Block ACK frame.

In some embodiments, the first frame may be or include various subfields. These subfields can be defined, configured, or reconfigured to request an SP extension. For example, at least one of these subfields can be used to request an SP extension without defining a new A-control field. While serving an original role, these subfields can serve as a request for an SP extension, when sent at or after a predetermined time point of an SP (e.g., at a time point with a predetermined time value until or close to the end of the SP). In some embodiments, when the first device (e.g., an STA, an AP) sends the second device (e.g., an AP, an STA) the first frame with the subfield discussed herein, the second device can recognize the subfield as an SP extension request.

In some embodiments, the first frame may include a subfield indicating a buffer size of traffic corresponding to one or more TIDs or one or more access categories (ACs) associated with the SP. The first frame can include an indication of non-zero buffer status to request the second device to extend the SP. For example, the subfield can indicate non-zero buffer status by (1) setting “Access Category Identifier (ACI) high” subfield (e.g., an ACI bitmap subfield of a corresponding frame) to a TID and setting “queue size high” subfield (e.g., of an ACI bitmap subfield) to a non-zero value, or (2) setting “queue size all” subfield (e.g., of an ACI bitmap subfield) to a non-zero value. In some embodiments, the indication can serve as an SP extension request from the predetermined time point. For example, when second device receives the indication after the predetermined time point, the indication can serve as an SP extension request. In some embodiments, the BSR can be delivered as a solicited response (e.g., to a BSR Poll (BSRP) trigger). In some embodiments, the BSR can be delivered as an unsolicited response.

In some embodiments, when set at a time point of an SP, a non-zero buffer indication for ACs or TIDs associated with the SP can serve as an SP extension request (e.g., via BSR Control or QoS Control). For example, when an individual TWT (I-TWT) or a broadcast TWT (B-TWT) is used, any non-zero BSR can serve as an SP extension request. For example, when a restricted TWT (R-TWT) is used, any non-zero BSR for any uplink TIDs (or corresponding ACs) can serve as an SP extension request.

In some embodiments, the first frame may include a subfield indicating power management (PM) (e.g., a PM subfield of a Frame Control field of a MAC layer frame) of the first device. The PM subfield can be set to indicate that the first device is in (or switches to) an active mode, to request the second device to extend the SP. In some embodiments, the PM subfield can serve its original role until a predetermined time point of an SP (e.g., at a time point with a predetermined time value until or close to the end of the SP), and can serve as an indication of an SP extension request from the predetermined time point. For example, when the PM subfield is set to indicate that the first device is in (or switches) to an active mode (e.g., the PM bit=0 in the MAC header) before the end of the SP (e.g., after the predetermined time point and before the end of the SP), the PM subfield can serve as an SP extension request. In some embodiments, both the subfield indicating a buffer size of traffic and the PM subfield can be set to serve as an SP extension request.

In some embodiments, a QoS control subfield can be used to indicate an SP extension request. The QoS control subfield may be carried in a MAC header in QoS Null frames or QoS data frames. In some embodiments, a power save (PS) Buffer State in the QoS control subfield can be set to serve as an SP extension request. For example, an indication of non-zero buffer in the subfield (e.g., setting the eighth to fifteenth bit of the QoS control subfield as a non-zero value when the subfield is 16-bit) can serve as an SP extension request from the AP. In some examples, the indication of non-zero buffer in the QoS control subfield can serve as an option for the AP to extend the SP. In some embodiments, the QoS control subfield can serve its original role until a predetermined time point of an SP (e.g., at a time point with a predetermined time value until or close to the end of the SP), and can serve as an indication of an SP extension request from the predetermined time point. For example, when the QoS control subfield is set to a non-zero value after the predetermined time point, the QoS control subfield can serve as an SP extension request.

The predetermined time point can be determined in various manners. In some embodiments, the predetermined time point can be specified and/or indicated as a fixed time value (e.g., 5 ms from/until/close to the end of the original SP). In some embodiments, the predetermined time point can be specified as a fixed time value or advertised by the AP. In some embodiments, any non-zero value during an SP can serve as an SP extension request. For example, any unsolicited non-zero buffer indication during an SP can serve as an SP extension request.

In some embodiments, the first device can receive, via the transceiver from the second device, a second frame indicating that the SP has been extended. The second frame can be configured in various manners to indicate that the SP has been extended.

In some embodiments, the second frame can include a subfield of the first frame set to a value indicating that the SP has been extended. For example, the first frame may include a subfield serving as an SP extension request, and the second frame can include a subfield (e.g., corresponding to the subfield of the first frame) to indicate an acceptance of the SP extension request. In some embodiments, the subfield can include a subfield (e.g., MoreTF subfield of a Common Info field of a Trigger frame) indicating whether there is a subsequent trigger frame, and the MoreTF subfield can be set to “1” to indicate an acceptance of the SP extension request. In some embodiments, the subfield can include a subfield (e.g., end of service period (EOSP) subfield of a QoS Control field of a MAC layer frame) indicating whether the SP has ended, and the EOSP subfield can be set to “0” to indicate an acceptance of the SP extension request. In some embodiments, the subfield can include a subfield (e.g., “MoreData” subfield of a Frame Control field of a MAC layer frame) indicating whether the first device has more data to send to the second device, and the MoreData subfield can be set to “1” to indicate an acceptance of the SP extension request. In some embodiments, the second frame can include a QoS control field that includes a subfield, and the subfield can be set to a value indicating that the SP has been extended. In some embodiments, a “Reserved” bit of the subfield can be used to indicate an acceptance of the SP extension request. For example, the second frame can include a QoS control field that includes a “Reserved” bit (e.g., the seventh bit in a QoS NULL packet). For example, any “Reserved” bit in the MAC header can be used to indicate an acceptance of the SP extension request. In some embodiments, in response to receiving an SP extension request from the first device (e.g., an AP), the second device (e.g., an STA) can switch to an active mode (e.g., by setting the PM bit to “0”) to indicate an acceptance of the SP extension request.

In some embodiments, responsive to receiving the second frame, the first device can wirelessly transmit, via the transceiver to the second device, a data frame after an end time of the original SP. In some embodiments, responsive to receiving the second frame, the first device can switch to an active mode (e.g., by setting the PM bit to “0”).

In some embodiments, the first device can receive, via the transceiver from the second device, a third frame indicating that the SP has been terminated. The third frame can be configured in various manners to indicate that the SP has been terminated.

In some embodiments, the third frame can include a subfield of the first frame set to a value indicating that the service period has been terminated. For example, the first frame may include a subfield serving as an SP extension request, and the second frame can include a subfield (e.g., corresponding to the subfield of the first frame) to indicate a termination of the SP. In some embodiments, the subfield can include a subfield (e.g., MoreTF subfield of a Common Info field of a Trigger frame) indicating whether there is a subsequent trigger frame, and the MoreTF subfield can be set to “0” to indicate a termination of the SP. In some embodiments, the subfield can include a subfield (e.g., end of service period (EOSP) subfield of a QoS Control field of a MAC layer frame) indicating whether the SP has ended, and the EOSP subfield can be set to “1” to indicate a termination of the SP. In some embodiments, the subfield can include a subfield (e.g., “MoreData” subfield of a Frame Control field of a MAC layer frame) indicating whether the first device has more data to send to the second device, and the MoreData subfield can be set to “0” to indicate a termination of the SP.

In some embodiments, responsive to receiving the third frame, the first device can switch from the active mode to a power save (PS) mode (e.g., by setting the PM bit to “1”). In some embodiments, the first device (e.g., an STA) can remain awake (e.g., active mode) until the end of the original SP in accordance with the baseline TWT rules. For example, when receiving the third frame before the end of the original SP, the first device (e.g., an STA) can remain awake until the end of the original SP in accordance with the baseline TWT rules. In some embodiments, after an extension of the SP, the first device switching to the PS mode can be considered as a termination of the SP (e.g., the extended SP). In some embodiments, when the first device (e.g., an AP) is in a “Responder PM” mode (e.g., when the first device is not available and/or in a doze state outside the TWT SPs), the first device can remain awake (e.g., by setting a “Responder PM” bit to “1”) after the end of the original SP and until the extended SP is terminated. In some embodiments, when I-TWT or R-TWT is used, the first device can be in the PS mode.

In some embodiments, an A-control subfield may include the fields of a plurality of HE controls (including HE control-1, HE control-2, . . . , HE control-N) and a padding. Each HE control may include the fields of control ID and control information. For BSR response, the control ID field may be set to a value (e.g., 3) indicating BSR. The control information field (or BSR control field) may include the subfields of ACI (Access Category Identifier) bitmap, delta TID, ACI high, scaling factor, queue size high, and/or queue size all. For example, in response to a buffer status report request (e.g., BSRP trigger frame) from an AP, a receiver STA may report its buffer status by specifying a queue size in the ‘queue size all’ subfield of a frame and sending the frame to the AP. Queue sizes may be reported for ACI indicated in the ACI bitmap subfield, which indicates the access category (or access categories) for which data stored in the STA's buffer is intended. Each bit of the ACI bitmap subfield can indicate the presence of a service intended for a corresponding AC. A value set in the delta TID subfield may indicate the number of TIDs corresponding to the number of bits in the ACI bitmap subfield that are set to 1. For example, if (1) the number of bits in the ACI bitmap subfield that are set to 1 equals 1, and (2) the delta TID is set to value 1, the delta TID may indicate 2 TIDs. If the number of bits in the ACI bitmap subfield that are set to 1 equals 0, values 0 to 2 in the delta TID may not be applicable, e.g., may not indicate the number of TIDs. A value set in the queue size all subfield may indicate/report a combined queue size of all ACs indicated in the ACI bitmap subfield. A value set in the queue size high subfield may indicate/report a queue size of ACI indicated in the ACI high subfield. In this manner, a queue size may be indicated for a specific AC (e.g., using the queue size high subfield), and/or for all backlogged traffic (e.g., using the queue size all subfield).

In some embodiments, a system may allow a STA to indicate a request for a TWT SP extension using non-zero buffer status for all traffic (e.g., all TIDs). If a STA indicates non-zero buffer status for all TIDs (or ACs) associated with an on-going SP, the non-zero buffer status indication may serve as a request for a TWT SP extension, as discussed above. For example, using a QoS control field, a STA may indicate non-zero buffer status for all TIDs. For example, for each TID of all the TIDs, the STA may indicate non-zero buffer status by setting (1) a first field to a TID; (2) a second field to 1; and (3) a fifth subfield to a non-zero value (e.g., non-zero buffer status/queue size). In some embodiments, the STA may indicate non-zero buffer status by aggregating multiple QoS control fields in a single frame. For example, using a BSR control subfield, a STA may indicate non-zero buffer status for all ACs in separate fields (e.g., different TIDs). For example, for each TID of all the TIDs, the STA may indicate non-zero buffer status by setting (1) the ACI high subfield to a TID; and (2) the queue size high subfield to a non-zero value (e.g., non-zero buffer status/queue size). In some embodiments, the STA may indicate non-zero buffer status by setting the queue size all subfield to a non-zero value (e.g., non-zero buffer status/queue size). In some embodiments, for R-TWT, a non-zero buffer status indication corresponding only to R-TWT uplink (UL) TIDs (which can be negotiated during the R-TWT setup) may serve as a request for a TWT SP extension. For other TWT schedules (e.g., I-TWT/B-TWT), a non-zero buffer status indication may serve as a request for a TWT SP extension. In some embodiments, (1) if an AP receives a non-zero buffer status indication in BSR for all TIDs corresponding to an on-going SP (e.g., using the queue size all subfield) and (2) if the AP has not completed delivery of traffic in DL to the STA, the AP may request a TWT SP extension.

In some embodiments, the system may allow a STA to indicate a request for a TWT SP extension using non-zero buffer status for any TID. BSR may be primarily used for UL multi-user (MU) scheduling, and a STA may deliver BSR of any TID when triggered by an AP, or may deliver BSR of any TID in unsolicited manner. If the STA has delivered all traffic, the STA may keep delivering non-zero buffer status. In order to indicate a request for a TWT SP extension, the STA may deliver non-zero buffer status of any TID (e.g., using the queue size high subfield) only when the STA has finished delivering traffic for the on-going SP. In this manner, non-zero buffer status received during an on-going SP may serve as a request for a TWT SP extension. A STA may deliver non-zero buffer status (for any TID or any AC or all ACs) during an on-going TWT SP to indicate to the AP or a peer STA that the STA does have some pending traffic for the remainder of the on-going TWT SP. If an AP receives non-zero buffer status from a STA during an on-going SP, the AP may extend the on-going SP.

In some embodiments, a STA can indicate a request for a TWT SP extension using non-zero buffer status for all traffic (e.g., all TIDs), only when delivering the non-zero buffer status as an unsolicited response. For example, (1) if an AP receives a non-zero buffer status indication in BSR for all TIDs (e.g., using the queue size all subfield) corresponding to an on-going SP as an unsolicited response, and (2) if the AP has not completed delivery of traffic to the STA, the AP may extend the SP. Similarly, a STA can indicate a request for a TWT SP extension using non-zero buffer status for any TID, only when delivering the non-zero buffer status as an unsolicited response. For example, (1) if an AP receives a non-zero buffer status indication in BSR for any TID (e.g., using the queue size high subfield) corresponding to an on-going SP as an unsolicited response, and (2) if the AP has not completed delivery of traffic to the STA, the AP may extend the on-going SP.

In one approach, a method can be provided. The method includes generating, by a first device (e.g., STA or AP) during a service period of a target wake time (TWT) schedule, a first frame requesting a second device in a wireless local area network (WLAN) to extend the service period, and wirelessly transmitting, by the first device via a transceiver, the generated first frame to the second device, wherein one of the first device or the second device is an access point.

In some embodiments, the method may include setting a first subfield of the first frame to a traffic identifier (TID) and a second subfield of the first frame to a specific serial number or sequence number, to request the second device to extend the service period until the second device receives all frames having serial numbers or sequence numbers that are less than or equal to the specific serial number or sequence number for a traffic stream with the TID.

In some embodiments, the method may include setting a subfield of the first frame to a minimum wake duration to request the second device to extend the service period for the minimum wake duration beyond an end time of the service period.

In some embodiments, the first frame may include a subfield indicating a buffer size of traffic corresponding to one or more traffic identifiers (TIDs) or one or more access categories (ACs) associated with the service period, and the method may include setting the subfield to a non-zero value to request the second device to extend the service period.

In some embodiments, the first frame may include a subfield indicating power management of the first device, and the method may include setting the subfield to indicate that the first device is in (or switches to) an active mode, to request the second device to extend the service period.

In some embodiments, the method may include receiving, via the transceiver from the second device, a second frame indicating that the service period has been extended, responsive to receiving the second frame, wirelessly transmitting, via the transceiver to the second device, a data frame after an end time of the service period, and receiving, via the transceiver from the second device, a third frame indicating that the service period has been terminated.

In some embodiments, the method may include responsive to receiving the second frame, switching the first device to an active mode, and responsive to receiving the third frame, switching the first device from the active mode to a power save mode.

In some embodiments, the second frame may include a subfield of the first frame set to a value indicating that the service period has been extended, and the subfield may include one of (1) a subfield indicating whether there is a subsequent trigger frame, (2) a subfield indicating whether the service period has ended, or (3) a subfield indicating whether the first device has more data to send to the second device.

In some embodiments, the second frame may include a quality of service (QOS) control field that includes a subfield set to a value indicating that the service period has been extended.

In some embodiments, the third frame may include a subfield of the first frame set to a value indicating that the service period has been terminated, and the subfield may include one of (1) a subfield indicating whether there is a subsequent trigger frame, (2) a subfield indicating whether the service period has ended, or (3) a subfield indicating whether the first device has more data to send to the second device.

Embodiments in the present disclosure have at least the following advantages and benefits. First, embodiments in the present disclosure can provide useful techniques for a device (e.g., an STA, an AP) to request an SP extension to another device (e.g., an AP, an STA). For example, the device can request an extension of an on-going SP, thereby securely completing delivery of data.

Second, embodiments in the present disclosure can provide useful techniques for the AP and the STA to perform a handshake procedure to extend an on-going SP of a TWT. This can prevent a delay in delivering data, thereby improving reliability, data integrity and user experience, while ensuring timely delivery of traffic.

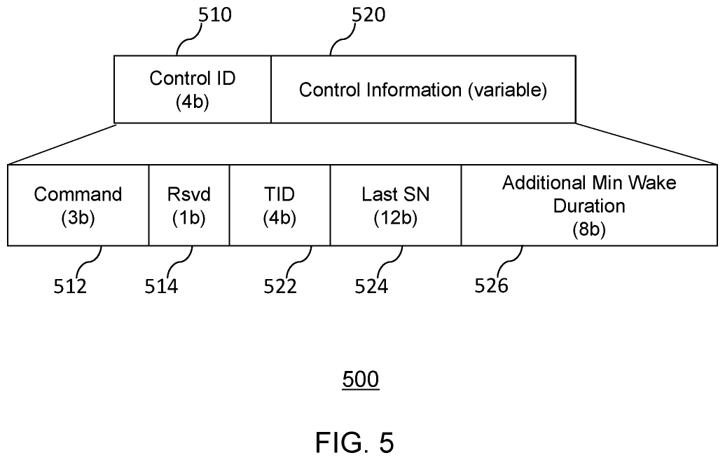

FIG. 5 is an example format of an aggregate control (A-control) subfield 500 of a control field for indicating a request for a TWT service period (SP) extension, according to an example implementation of the present disclosure. In some embodiments, the A-control field may be a High Efficiency (HE) variant control field in a medium access control (MAC) header. In some embodiments, the A-control field can be used for an SP extension or any other SP management (e.g., TWT SP management). In some embodiments, the A-control field can include various elements for the SP management (e.g., SP extension). In some embodiments, the A-control field may include a Control ID field 510 and a Control Information field 520, and each field can include one or more subfields.

In some embodiments, the Control ID field 510 can include a subfield for identifying the SP management (e.g., SP extension). In some embodiments, a size of the Control ID field 510 may be 4 bits. In some embodiments, the Control ID field 510 can include a Command subfield 512 to specify a request for an SP extension or a response to an SP extension. By specifying the Command subfield 512, one or more of the plurality of subfields within the Control Information field 520 can be set and/or defined to define the A-control field 500. In some embodiments, the Control ID field 510 can include a reserved (Rsvd) subfield 514 that can be further specified in the future. As shown in FIG. 5, in a non-limiting example, the Control ID field 510 may be 4 bits, the Command subfield 512 may be 3 bits, and the Rsvd subfield 514 may be 1 bit.

In some embodiments, the Control Information field 520 can include a plurality of subfields for the SP management (e.g., SP extension).

In some embodiments, the Control Information field 520 can include a traffic identifier (TID) subfield 522 to indicate an identification of the traffic. In some embodiments, the Control Information field 520 can include a serial number (SN) subfield to indicate a serial number or sequence number of the frame. In some embodiments, the Control Information field 520 can include a Last SN subfield 524 to indicate the last sequence number for the SP. In some embodiments, the Control Information field 520 can include a subfield 526 to indicate an Additional Minimum Wake Duration. The subfield 526 can define and/or specify an additional duration of an SP to be requested.

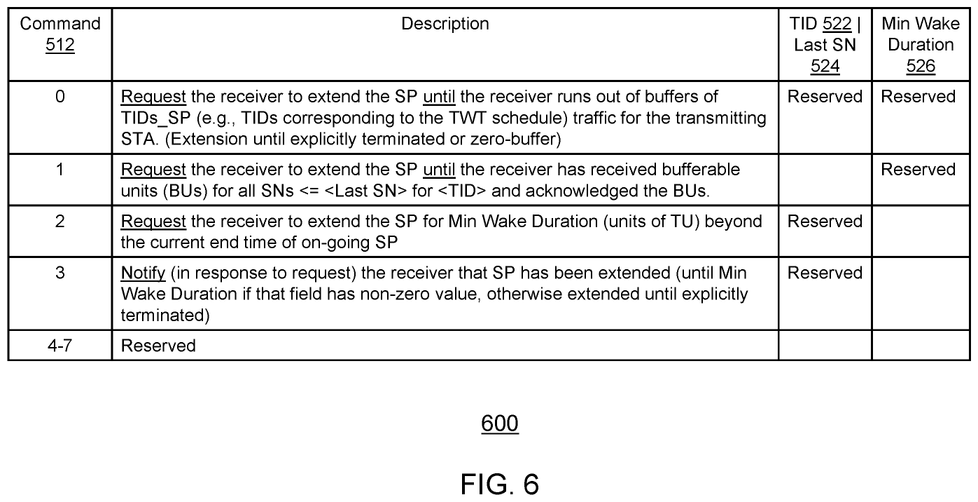

FIG. 6 is a table 600 of example values and description for the A-control field 500, according to an example implementation of the present disclosure. Discussed herein are non-limiting examples of the subfields, and various subfields can be set and defined to define the A-control field 500 to request the SP extension in various manners.

In some embodiments, the Control Information field 520 can be configured to define a request for an SP extension such that the second device can extend the SP until the SP is explicitly terminated or no buffer is available (e.g., when the second device runs out of the buffer for the first device or the STA transmitting the traffic). In some embodiments, the subfields (e.g., the TID subfield 522, the Last SN subfield 524, the subfield 526 (for Additional Min Wake Duration), etc.) can be set to “Reserved” to be further specified. In some embodiments, the Command subfield can be specified as “0.”

In some embodiments, the Control Information field 520 can be configured to define a request for an SP extension such that the second device can extend the SP until the second device receives all frames having SNs that are less than or equal to a specific SN for a traffic stream with the TID. For example, the second device can extend the SP until the second device receives all frames having SNs that are less than or equal to the SN of the last frame for the specified TID. For example, the second device can extend the SP until the second device receives all bufferable units (BUs) for all SNs that are less than or equal to the SN of the last frame for the specified TID. In some embodiments, a first subfield of the first frame can be set to a TID, and a second subfield of the first frame can be set to a specific SN, in order to define the request, while the other subfields (e.g., the subfield 526 for Additional Min Wake Duration, etc.) can be set to “Reserved” to be further specified for various purposes. In some embodiments, the Command subfield can be specified as “1.”

In some embodiments, the Control Information field 520 can be configured to define a request for an SP extension such that the second device can extend the SP for a minimum wake duration beyond an end time (e.g., a configured end time) of the SP. For example, the second device can extend the SP for a duration (e.g., specified in the subfield 526 for the Additional Min Wake Duration (e.g., in time unit (TU)) beyond the current end time of the on-going SP). In some embodiments, a subfield of the first frame can be set to specify an Additional Min Wake Duration, in order to define the request, while the other subfields (e.g., the TID subfield 522, the Last SN subfield 524, etc.) can be set to “Reserved” to be further specified for various purposes. In some embodiments, the Command subfield can be specified as “2.”

In some embodiments, the Control Information field 520 can be configured to define a response to an SP extension request such that the first device can notify the second device that the SP has been extended. In some embodiments, the first device can notify the second device that the SP has been extended in a manner specified in the SP extension request (e.g., in a manner discussed above). In some embodiments, the first device can notify the second device that the SP has been extended, for example, until the specified Additional Min Wake Duration (e.g., if the subfield therefor, for example the subfield 526, has a non-zero value), or until explicitly terminated. In some embodiments, at least one subfield of the first frame can be set to Additional Min Wake Duration (e.g., the subfield 526), TID (e.g., the subfield 522), or Last SN (e.g., the subfield 524), in order to define the response to the SP extension request, while the other subfields can be set to “Reserved” to be further specified for various purposes. For example, a subfield of the first frame can be set to Additional Min Wake Duration, while the subfields of TID (e.g., 522) and Last SN (e.g., 524) can be set to “Reserved” to be further specified for various purposes. In some embodiments, the Command subfield 512 can be specified as “3.” In some embodiments, the Command subfield 512 can include one or more bits that can be further specified (e.g., “Reserved”) for various purposes. For example, the Command subfield 512 can be 8 bits, and the fifth to eighth bit can be further specified (e.g., “Reserved”) for various purposes.

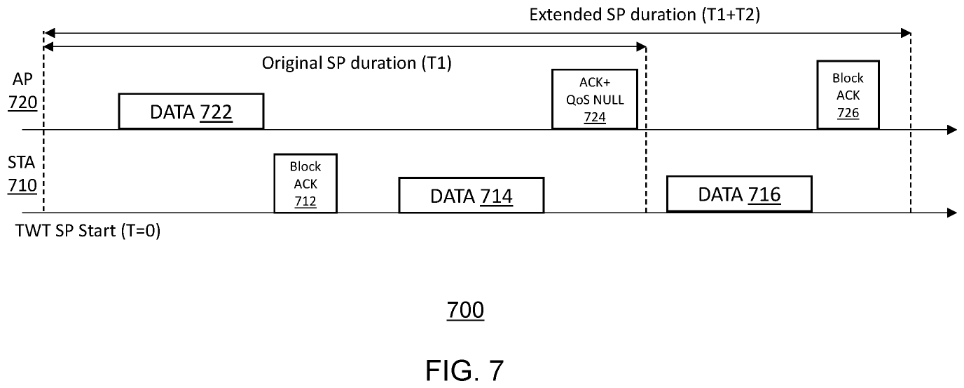

In some embodiments, an STA (or an AP) can request an extension and an AP (or an STA) can respond to the extension request according to the A-control field 500 discussed above and configuration thereof (e.g., the table 600). FIG. 7 is a schematic view 700 of an example TWT SP extension using the A-control field 500, according to an example implementation of the present disclosure. When a TWT SP with an original period of T1 begins at T=0, an STA 710 and an AP 720 can communicate data within the TWT SP. For example, the AP 720 can send data 722, and the STA can acknowledge as a block (e.g., send a Block ACK frame 712) to confirm receipt of the data 722. For example, the STA 710 can send data 714, and the AP 720 can send a Block ACK frame to confirm receipt of the data 714. In some embodiments, the STA 710 can send the data 714 along with a frame including the A-control field 500 to request an SP extension, which can vary according to how the extension is defined in the A-control field 500. For example, the STA 710 can include, within or along with the data 714, a frame including a TWT SP Management field with the Command subfield 512 of “2” (e.g., with specified Additional Min Wake Duration, T2). In response to receipt of the request (e.g., within the data 714 from the STA 710), the AP 720 can acknowledge as a block to confirm receipt of the data 714 and the extension request. In some embodiments, in order to respond to the request, the AP 720 can accept the request and notify the STA 710 with the Command subfield 512 of “3.” In some embodiments, the AP 720 can acknowledge as a block to confirm receipt of the data from the STA 710 while sending a frame including a TWT SP Management field with the Command subfield 512 of “3” to convey an acceptance of the request. In some embodiments, the AP 720 can reject the request. In some embodiments, the AP 720 can send a frame 724 including Quality of Service (QOS) related information (e.g., QoS NULL) along with an acceptance of the request. The AP 720 can thereby accept and extend the SP from the original period T1 to an extended SP duration of T1+T2 (e.g., if an additional period of T2 is requested) or extend until explicitly terminated. In response to the extension of the SP, the STA 710 can further send data 716 to the AP 720, and the AP 720 can confirm receipt of the data by sending a Block ACK frame 726.

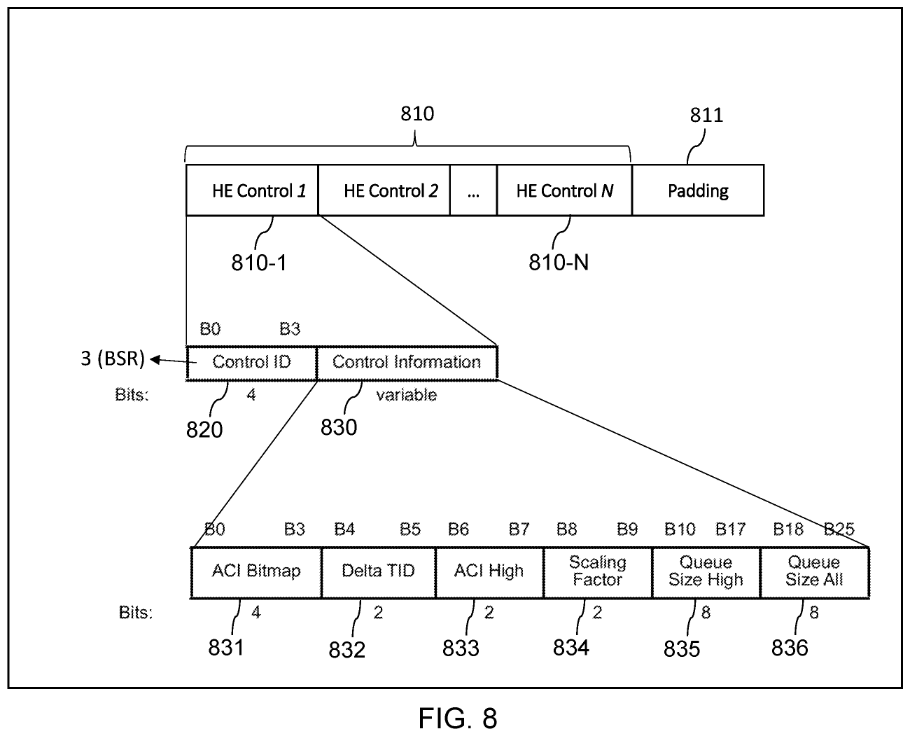

FIG. 8 is an example format of an A-control subfield 800 of a High Efficiency (HE) variant High Throughput (HT) control field for indicating a request for a TWT SP extension, according to an example implementation of the present disclosure. In some embodiments, the A-control subfield 800 may include the fields of a plurality of HE controls 810 (including HE control-1 810-1, HE control-2 810-2, . . . , HE control-N 810-N) and a padding 811. Each HE control may include the fields of control ID 820 and control information 830. For BSR response, the control ID field 820 may be set to a value (e.g., 3) indicating BSR. The control information field (or BSR control field) 830 may include the subfields of ACI (Access Category Identifier) bitmap 831, delta TID 832, ACI high 833, scaling factor 834, queue size high 835, and/or queue size all 836. For example, in response to a buffer status report request (e.g., BSRP trigger frame) from an AP, a receiver STA may report its buffer status by specifying a queue size in the ‘queue size all’ subfield 836 of a frame and sending the frame to the AP. Queue sizes may be reported for ACI indicated in the ACI bitmap subfield 831, which indicates the access category (or access categories) for which data stored in the STA's buffer is intended. Each bit of the ACI bitmap subfield 831 can indicate the presence of a service intended for a corresponding AC. A value set in the delta TID subfield 832 may indicate the number of TIDs corresponding to the number of bits in the ACI bitmap subfield 831 that are set to 1. For example, if (1) the number of bits in the ACI bitmap subfield 831 that are set to 1 equals 1, and (2) the delta TID 832 is set to value 1, the delta TID 832 may indicate 2 TIDs. If the number of bits in the ACI bitmap 831 subfield that are set to 1 equals 0, values 0 to 2 in the delta TID 832 may not be applicable, e.g., may not indicate the number of TIDs. A value set in the queue size all subfield 836 may indicate/report a combined queue size of all ACs indicated in the ACI bitmap subfield 831. A value set in the queue size high subfield 835 may indicate/report a queue size of ACI indicated in the ACI high subfield 833. In this manner, a queue size may be indicated for a specific AC (e.g., using the queue size high subfield 835), and/or for all backlogged traffic (e.g., using the queue size all subfield 836).

In some embodiments, a system may allow a STA to indicate a request for a TWT SP extension using non-zero buffer status for all traffic (e.g., all TIDs). If a STA indicates non-zero buffer status for all TIDs (or ACs) associated with an on-going SP, the non-zero buffer status indication may serve as a request for a TWT SP extension, as discussed above. For example, using a QoS control field, a STA may indicate non-zero buffer status for all TIDs. For example, for each TID of all the TIDs, the STA may indicate non-zero buffer status by setting (1) a first field to a TID; (2) a second field to 1; and (3) a fifth subfield to a non-zero value (e.g., non-zero buffer status/queue size). In some embodiments, the STA may indicate non-zero buffer status by aggregating multiple QoS control fields in a single frame. For example, using a BSR control subfield 830, a STA may indicate non-zero buffer status for all ACs in separate fields (e.g., different TIDs). For example, for each TID of all the TIDs, the STA may indicate non-zero buffer status by setting (1) the ACI high subfield 833 to a TID; and (2) the queue size high subfield 835 to a non-zero value (e.g., non-zero buffer status/queue size). In some embodiments, the STA may indicate non-zero buffer status by setting the queue size all subfield 836 to a non-zero value (e.g., non-zero buffer status/queue size). In some embodiments, for R-TWT, a non-zero buffer status indication corresponding only to R-TWT uplink (UL) TIDs (which can be negotiated during the R-TWT setup) may serve as a request for a TWT SP extension. For other TWT schedules (e.g., I-TWT/B-TWT), a non-zero buffer status indication may serve as a request for a TWT SP extension. In some embodiments, (1) if an AP receives a non-zero buffer status indication in BSR for all TIDs corresponding to an on-going SP (e.g., using the queue size all subfield 836) and (2) if the AP has not completed delivery of traffic in DL to the STA, the AP may request a TWT SP extension.

In some embodiments, the system may allow a STA to indicate a request for a TWT SP extension using non-zero buffer status for any TID. BSR may be primarily used for UL multi-user (MU) scheduling, and a STA may deliver BSR of any TID when triggered by an AP, or may deliver BSR of any TID in unsolicited manner. If the STA has delivered all traffic, the STA may keep delivering non-zero buffer status. In order to indicate a request for a TWT SP extension, the STA may deliver non-zero buffer status of any TID (e.g., using the queue size high subfield 835) only when the STA has finished/completed delivering traffic for the on-going SP. In this manner, non-zero buffer status received during an on-going SP may serve as a request for a TWT SP extension. A STA may deliver non-zero buffer status (for any TID or any AC or all ACs) during an on-going TWT SP to indicate to the AP or a peer STA that the STA does have some pending traffic for the remainder of the on-going TWT SP. If an AP receives non-zero buffer status from a STA during an on-going SP, the AP may extend the on-going SP.

In some embodiments, a STA can indicate a request for a TWT SP extension using non-zero buffer status for all traffic (e.g., all TIDs), only when delivering the non-zero buffer status as an unsolicited response. For example, (1) if an AP receives a non-zero buffer status indication in BSR for all TIDs (e.g., using the queue size all subfield 836) corresponding to an on-going SP as an unsolicited response, and (2) if the AP has not completed delivery of traffic to the STA, the AP may extend the SP. Similarly, a STA can indicate a request for a TWT SP extension using non-zero buffer status for any TID, only when delivering the non-zero buffer status as an unsolicited response. For example, (1) if an AP receives a non-zero buffer status indication in BSR for any TID (e.g., using the queue size high subfield 835) corresponding to an on-going SP as an unsolicited response, and (2) if the AP has not completed delivery of traffic to the STA, the AP may extend the on-going SP.

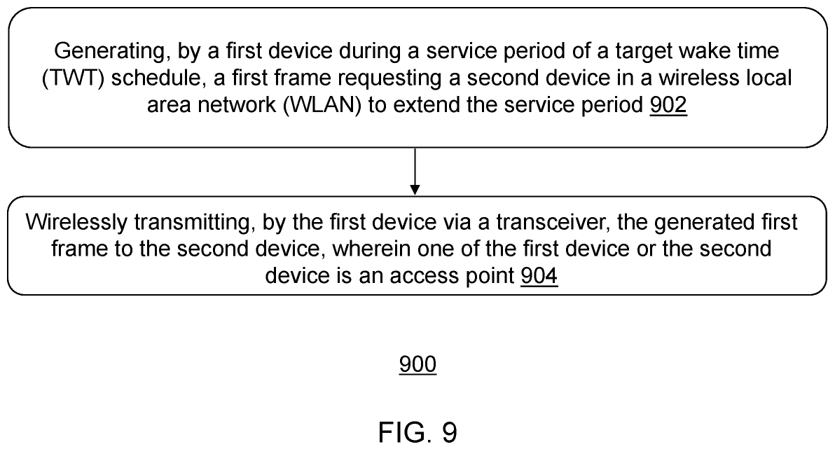

FIG. 9 is a flowchart showing a method 900 of performing an extension of a TWT SP, according to an example implementation of the present disclosure. In some embodiments, the method 900 can be performed by the first device (e.g., an STA, an AP) as discussed above. In some embodiments, the method 900 can be performed by other entities. In some embodiments, the method 900 may include more, fewer, or different steps than shown in FIG. 9.

The method 900 can include generating, by a first device during a SP of a target wake time (TWT) schedule, a first frame requesting a second device in a wireless local area network (WLAN) to extend the SP (902 of the method 900). The method 900 can include wirelessly transmitting, by the first device via a transceiver, the generated first frame to the second device, wherein one of the first device or the second device is an access point (904 of the method 900).

In some embodiments, the method 900 may include the first device setting a first subfield (e.g., 522) of the first frame to a traffic identifier (TID) and a second subfield (e.g., 524) of the first frame to a specific serial number or sequence number, to request the second device to extend the SP until the second device receives all frames having serial numbers or sequence numbers that are less than or equal to the specific serial number or sequence number for a traffic stream with the TID.

In some embodiments, the method 900 may include the first device setting a subfield (e.g., 526) of the first frame to a minimum wake duration to request the second device to extend the SP for the minimum wake duration beyond an end time (e.g., a configured end time) of the SP.

In some embodiments, the first frame may include a subfield indicating a buffer size of traffic corresponding to one or more traffic identifiers (TIDs) or one or more access categories (ACs) associated with the SP, and the method 900 may include the first device setting the subfield to a non-zero value to request the second device to extend the SP.

In some embodiments, the first frame may include a subfield (e.g., a PM subfield) indicating power management of the first device, and the method 900 may include the first device setting the subfield to indicate that the first device is in (or switches to) an active mode, to request the second device to extend the SP.

In some embodiments, the method 900 may include the first device receiving, via the transceiver from the second device, a second frame indicating that the SP has been extended, responsive to receiving the second frame, wirelessly transmitting, via the transceiver to the second device, a data frame after an end time of the SP, and receiving, via the transceiver from the second device, a third frame indicating that the SP has been terminated.

In some embodiments, the method 900 may include the first device responsive to receiving the second frame, switching the first device to an active mode, and responsive to receiving the third frame, switching the first device from the active mode to a power save mode.

In some embodiments, the second frame may include a subfield of the first frame set to a value indicating that the SP has been extended, and the subfield may include one of (1) a subfield indicating whether there is a subsequent trigger frame, (2) a subfield indicating whether the SP has ended, or (3) a subfield indicating whether the first device has more data to send to the second device.

In some embodiments, the second frame may include a quality of service (QOS) control field that includes a subfield set to a value indicating that the SP has been extended. In some embodiments, the third frame may include a subfield of the first frame set to a value indicating that the SP has been terminated, and the subfield may include one of (1) a subfield indicating whether there is a subsequent trigger frame, (2) a subfield indicating whether the SP has ended, or (3) a subfield indicating whether the first device has more data to send to the second device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
generate, during a service period of a target wake time (TWT) schedule, a first frame requesting a second device in a wireless local area network (WLAN) to extend the service period; and
wirelessly transmit, via a transceiver, the generated first frame to the second device, wherein one of the first device or the second device is an access point.

2. The first device according to claim 1, wherein the one or more processors are configured to:
set a first subfield of the first frame to a traffic identifier (TID) and a second subfield of the first frame to a specific serial number or a sequence number, to request the second device to extend the service period until the second device receives all frames having serial numbers or sequence numbers that are less than or equal to the specific serial number or sequence number for a traffic stream with the TID.

3. The first device according to claim 1, wherein the one or more processors are configured to:
set a subfield of the first frame to a minimum wake duration to request the second device to extend the service period for the minimum wake duration beyond an end time of the service period.

4. The first device according to claim 1, wherein
the first frame comprises a subfield indicating a buffer size of traffic corresponding to one or more traffic identifiers (TIDs) or one or more access categories (ACs) associated with the service period, and
the one or more processors are configured to set the subfield to a non-zero value to request the second device to extend the service period.

5. The first device according to claim 1, wherein
the first frame comprises a subfield indicating power management of the first device, and
the one or more processors are configured to set the subfield to indicate that the first device is in or switches to an active mode, to request the second device to extend the service period.

6. The first device according to claim 1, wherein the one or more processors are configured to:
receive, via the transceiver from the second device, a second frame indicating that the service period has been extended;
responsive to receiving the second frame, wirelessly transmit, via the transceiver to the second device, a data frame after an end time of the service period; and
receive, via the transceiver from the second device, a third frame indicating that the service period has been terminated.

7. The first device according to claim 6, wherein the one or more processors are configured to:
responsive to receiving the second frame, switch the first device to an active mode; and
responsive to receiving the third frame, switch the first device from the active mode to a power save mode.

8. The first device according to claim 6, wherein
the second frame comprises a subfield of the first frame set to a value indicating that the service period has been extended, and
the subfield comprises one of (1) a subfield indicating whether there is a subsequent trigger frame, (2) a subfield indicating whether the service period has ended, or (3) a subfield indicating whether the first device has more data to send to the second device.

9. The first device according to claim 6, wherein
the second frame comprises a quality of service (QOS) control field that comprises a subfield set to a value indicating that the service period has been extended.

10. The first device according to claim 6, wherein
the third frame comprises a subfield of the first frame set to a value indicating that the service period has been terminated, and
the subfield comprises one of (1) a subfield indicating whether there is a subsequent trigger frame, (2) a subfield indicating whether the service period has ended, or (3) a subfield indicating whether the first device has more data to send to the second device.

11. A method comprising:
generating, by a first device during a service period of a target wake time (TWT) schedule, a first frame requesting a second device in a wireless local area network (WLAN) to extend the service period; and
wirelessly transmitting, by the first device via a transceiver, the generated first frame to the second device, wherein one of the first device or the second device is an access point.

12. The method according to claim 11, further comprising:
setting a first subfield of the first frame to a traffic identifier (TID) and a second subfield of the first frame to a specific serial number or a sequence number, to request the second device to extend the service period until the second device receives all frames having serial numbers or sequence numbers that are less than or equal to the specific serial number or sequence number for a traffic stream with the TID.

13. The method according to claim 11, further comprising:
setting a subfield of the first frame to a minimum wake duration to request the second device to extend the service period for the minimum wake duration beyond an end time of the service period.

14. The method according to claim 11, wherein
the first frame comprises a subfield indicating a buffer size of traffic corresponding to one or more traffic identifiers (TIDs) or one or more access categories (ACs) associated with the service period, and
the method comprises setting the subfield to a non-zero value to request the second device to extend the service period.

15. The method according to claim 11, wherein
the first frame comprises a subfield indicating power management of the first device, and
the method comprises setting the subfield to indicate that the first device is in or switches to an active mode, to request the second device to extend the service period.

16. The method according to claim 11, further comprising:
receiving, via the transceiver from the second device, a second frame indicating that the service period has been extended;
responsive to receiving the second frame, wirelessly transmitting, via the transceiver to the second device, a data frame after an end time of the service period; and
receiving, via the transceiver from the second device, a third frame indicating that the service period has been terminated.

17. The method according to claim 16, further comprising:
responsive to receiving the second frame, switching the first device to an active mode; and
responsive to receiving the third frame, switching the first device from the active mode to a power save mode.

18. The method according to claim 16, wherein
the second frame comprises a subfield of the first frame set to a value indicating that the service period has been extended, and
the subfield comprises one of (1) a subfield indicating whether there is a subsequent trigger frame, (2) a subfield indicating whether the service period has ended, or (3) a subfield indicating whether the first device has more data to send to the second device.

19. The method according to claim 16, wherein
the second frame comprises a quality of service (QOS) control field that comprises a subfield set to a value indicating that the service period has been extended.

20. The method according to claim 16, wherein
the third frame comprises a subfield of the first frame set to a value indicating that the service period has been terminated, and
the subfield comprises one of (1) a subfield indicating whether there is a subsequent trigger frame, (2) a subfield indicating whether the service period has ended, or (3) a subfield indicating whether the first device has more data to send to the second device.
